(19) United States
(12) Patent Application Publication
(10) Pub. No.: US 2026/0085880 A1
(43) Pub. Date: Mar. 26, 2026

(54) HOUSEHOLD APPLIANCE APPARATUS AND HOUSEHOLD APPLIANCE

(71) Applicant: BSH Hausgeräte GmbH, München (DE)

(72) Inventors: Armin WEBER, Lauchheim (DE); Stephan KEMPFLE, Ellzee (DE); Harald JOKSCH, Vöhringen (DE); Bernd OSBAR, Aalen (DE); Andreas HIRSCHBOLZ, Syrgenstein (DE)

(21) Appl. No.: 19/317,384

(22) Filed: Sep. 3, 2025

(30) Foreign Application Priority Data
Sep. 24, 2024 (DE) 10 2024 209 161.8

(51) Int. Cl. F25D 29/00; H04L 12/40

(52) U.S. Cl. CPC F25D 29/005; H04L 12/40

(57) ABSTRACT

A household appliance apparatus, in particular a household refrigerator apparatus, includes a housing which defines a usable space, in particular a refrigeration space, a power control device, a primary control device which is spatially separate from the power control device, and a bus connection for combined power and data transmission between the power control device and the primary control device. The power control device is disposed in a lower area of the housing and the primary control device is disposed in an upper area of the housing. A household appliance having the household appliance apparatus is also provided.

### CROSS-REFERENCE TO RELATED APPLICATION

This application claims the priority, under 35 U.S.C. § 119, of German Patent Application DE 10 2024 209 161.8, filed Sep. 24, 2024; the prior application is herewith incorporated by reference in its entirety.

### FIELD AND BACKGROUND OF THE INVENTION

The invention relates to a household appliance apparatus, in particular a household refrigerator apparatus, and a household appliance having the household appliance apparatus.

Modern refrigerators for household use are controlled and/or regulated by an electronic controller or by control devices. The controller in that case carries out testing and interrogation of sensors, control of different electrical consumer units, connection of the devices to a data network at the customer's site as well as regulation of a refrigeration process and other processes.

In the known solutions, use is made of a central control device. The control device controls and regulates all electronic components in the device. For example, electrical signals from sensors are received and processed by the central control device, and device lighting, a heater and actuators are predominantly controlled. A particular disadvantage of that solution is that a large number of electrical cables is necessary to connect all electrical components to the central control device.

Due to the large number of electronic cables the electrical components of the household appliance apparatus are disturbed by unwanted electrical and electromagnetic effects, which can result in problems as regards electromagnetic compatibility. Furthermore, the central control device must be configured such that it can be used with a maximum device configuration, for example with a maximum number of sensors and usable spaces, predominantly refrigerated spaces. As a result, in a large number of household appliances the central control device is not fully utilized, but the high costs of the central control device still remain.

Furthermore, household appliances, including refrigerators, are operated directly via the country-specific power supply network. Electrical consumer units and sensors are in that case controlled via a DC power pack, in order to minimize safety risks. The DC power pack supplies all DC consumer units in the device, including fans, lighting elements, sensors, etc., and is also used for supplying the voltage to the central control device, which takes over the device control and regulation. The DC power pack in that case has a circuit structure that transforms a voltage of the power supply network into a safety extra low voltage (SELV), which because of its low level and the insulation against higher-voltage circuits offers particular protection against an electric shock. Previous DC power packs were integrated into the central control device or were part of the central control device. Depending on the type of device, different performance classes of DC power packs are required in that case, as a result of which different central control devices have to be developed, manufactured and certified, which, as described above, always have to be configured for the full device configuration. That leads to a high configuration outlay and thus to high manufacturing costs.

Furthermore, refrigerators have an electrical interface in the area of the power unit. That interface serves to supply and program the devices during production, to connect the country-specific main connection cable, which provides an AC voltage, to the device and to connect a compressor. Where necessary, filter modules can likewise be placed thereon to improve the country-specific voltage supply. However, in those refrigerators the AC voltage is disadvantageously still conducted from the electrical interface to the central control device, and only there is it transformed by the DC power pack into a DC voltage. The connection between the electrical interface and the DC power pack is in that case realized by electrical cables which are primarily routed through insulation layers of the refrigerators and thus on the one hand contribute to unnecessary warming and on the other hand to manufacturing costs.

Furthermore, due to unwanted electrical and electromagnetic effects the electrical cables may disturb the electronic components of the household appliance apparatus, which may result in problems as regards electromagnetic compatibility.

### SUMMARY OF THE INVENTION

It is accordingly an object of the invention to provide a household appliance apparatus and a household appliance, which overcome the hereinafore-mentioned disadvantages of the heretofore-known apparatuses and appliances of this general type and in which control devices thereof can be adapted straightforwardly to the device configuration, which heats up less, which is easier to manufacture and/or has a higher electromagnetic compatibility.

With the foregoing and other objects in view there is provided, in accordance with one aspect of the invention, a household appliance apparatus, in particular a household refrigerator apparatus, with a power control device, with a primary control device, with at least one function control device which is configured to operate a specific function of a household appliance, and with a bus connection for combined power and data transmission, wherein the power control device, the primary control device and the at least one function control device are connected via the bus connection.

With the foregoing and other objects in view there is provided, in accordance with another aspect of the invention, household appliance apparatus, in particular a household refrigerator apparatus, with a housing which defines a usable space, in particular a refrigeration space, with a power control device, with a primary control device which is spatially separated from the power control device, and with a bus connection for combined power and data transmission between the power control device and the primary control device, wherein the power control device is disposed in a lower area of the housing and the primary control device in an upper area of the housing.

With the foregoing and other objects in view there is provided, in accordance with a further aspect of the invention, a household appliance apparatus, in particular a household refrigerator apparatus, with a power control device, with a primary control device and with a bus connection for combined power and data transmission between the power control device and the primary control device, wherein the power control device and the primary control device for power and data transmission are connected exclusively via the bus connection.

Advantageous embodiments and developments of the invention can be taken from the dependent claims.

The aforementioned aspects of the invention can in this case be considered individually or else in combination with one another. The invention further relates to a household appliance with an inventive household appliance apparatus.

Due to the inventive household appliance apparatus the number of cables can be minimized. As a result, costs can be minimized and any problems as regards electromagnetic compatibility can be reduced. Furthermore, the modular structure with control devices, separated from one another, of the inventive household appliance apparatus with the power control device, the primary control device and/or the at least one function control device make possible a targeted adaptation of the control devices to functions of the household appliance. In other words, due to the modular structure it is not necessary, or not necessary to the previous extent, to store on the control devices functionalities which are not used in an actual household appliance configuration. Furthermore, all household appliance configurations can be covered with one single electronics architecture. Further, the complexity of the individual control devices can be very greatly reduced. In this case control devices which are employed in all or most household appliance configurations, in particular the power control device and/or the primary control device, can be produced in very large numbers and thus at less cost. The control devices, in particular the at least one function control device, which are employed in only a few household appliance configurations can have less complexity and as a result become less expensive.

Furthermore, by separating the power control device from the primary control device the different types of device and value classes can be represented by employing different power control devices. In this case the rest of the electronics concept of the household appliance apparatus, in particular the primary control device and/or the at least one function control device, remains unchanged, with only the power control device being adapted. Furthermore, the power supply can be connected directly to the power control device and as a result an additional interface for the connection of the power supply can be saved.

In particular, by arranging the primary control device in the upper area of the housing, the height of the housing in the upper area can be reduced. In particular, as a result it is possible to reduce the height of a top panel of the housing. Furthermore, by arranging the primary control device in the upper area of the housing and the power control device in the lower area of the housing, the heat input in the upper area of the household appliance changes, in which for example refrigeration components may be disposed. The primary control device can in particular be disposed on the top of the housing.

The household appliance apparatus can be part, preferably a subassembly, of a household appliance, for example of a laundry treatment appliance, a cooking appliance, a dishwasher and preferably a refrigerator, in particular a refrigeration and/or freezer cabinet.

The power control device, the primary control device and/or the function control device can each include a printed circuit board. The printed circuit board can be accommodated in a housing of the respective device. The power control device, the primary control device and/or the function control device can be galvanically isolated from one another and connected to one another by the bus connection, in particular exclusively by the bus connection. In other words, the power control device, the primary control device and the function control device do not have a common printed circuit board and/or are not disposed on a common printed circuit board.

In some configurations, energy can be transmitted via the bus connection in at least one direction and data in both directions.

The power control device can for example have an interface to a country-specific supply line and/or can supply the primary control device and the at least one function control device with electrical energy. Furthermore, the power control device can control and/or regulate further consumer units of the household appliance apparatus and in particular of the household appliance, and/or supply them with energy. The primary control device can for example include a user interface. Furthermore, the primary control device can be configured to coordinate and/or to control and/or to regulate the power control device and the at least one function control device. The at least one function control device can be configured to control and/or regulate a functional unit of a household appliance, in particular an ice maker and/or a no-frost unit.

The housing can have an inner housing, an outer housing and an insulating layer therebetween. The inner housing can here be formed of a plastic material and can preferably be produced by thermoforming. The outer housing can be formed of a metal material, preferably made of sheet metal. The insulating layer can be a foam material, in particular a PU foam, which is introduced during the production of the housing and/or of the household appliance by foaming an intermediate space between the inner housing and the outer housing.

The housing can surround and/or define a usable space and/or a further usable space. In particular, the usable space and/or the further usable space can be defined by the inner housing. The usable space can be disposed above the further usable space. The usable space can be a refrigeration space and the further usable space can be a freezing space. Furthermore, the household appliance apparatus and in particular the household appliance can have a door hinged to the housing, in order to close the usable space and/or the further usable space. In this case a separate door could be provided for each usable space or else a common door for both usable spaces.

The upper area of the housing can be disposed above the usable space and the lower area of the housing can be disposed below the usable space and/or the further usable space. Furthermore, the upper area of the housing can also be disposed at the height of the usable space and the lower area of the housing at the height of the further usable space. As regards a height extension of the housing, the upper area of the housing can extend over an upper half of the housing. As regards the height extension of the housing, the lower area of the housing can extend over a lower half of the housing. Viewed along the height extension of the housing, all points of the upper area of the housing are spaced apart from an upper edge of the housing by a maximum of 60 cm, in particular by a maximum of 40 cm and advantageously by a maximum of 20 cm. Viewed along the height extension of the housing, all points of the lower area of the housing are spaced apart from a lower edge of the housing by a maximum of 60 cm, in particular by a maximum of 40 cm and advantageously by a maximum of 20 cm.

In order to be able to adapt the household appliance apparatus optimally to the household appliance configuration, the at least one function control device can include a refrigeration system controller and/or an ice maker controller and/or a no-frost controller.

Alternatively or additionally, the household appliance apparatus can also include a function control device with a refrigeration controller and/or a further function control device with an ice maker controller and/or an additional function control device with a no-frost controller. By separating the individual controllers into individual function control devices the number of function control devices, which is common to many household appliance configurations, can be increased.

The refrigeration system controller can be configured to regulate a temperature in a refrigeration space and/or freezing space, in particular of the household appliance. The ice maker controller can be configured to control and/or regulate an ice maker, in particular an ice-cube maker, of the household appliance apparatus and in particular of the household appliance. The ice maker can be configured to produce and provide ice and in particular ice cubes. The no-frost controller can be configured to refrigerate a refrigeration space and/or freezing space and/or to prevent ice or frost from forming in a refrigeration space and/or a freezing space, in particular of the household appliance.

The at least one function control device can include and/or be a heat exchange unit control module and/or an ice water system control module and/or a feature control module. The household appliance apparatus can include a function control device which includes or is a heat exchange unit control module. The household appliance apparatus can additionally or alternatively include a function control device which includes or is an ice water system control module. The household appliance apparatus can additionally or alternatively include a function control device which includes or is an up-selling control module. The heat exchange unit control module in particular includes control electronics for individual no-frost controllers. The ice water system control module can include control electronics for controlling an ice maker. The feature control module can include control electronics for the targeted control of further electrical consumer units. The further electrical consumer units can in particular be electrical consumer units for additional functions which are employed in few household appliance configurations, for example hygiene monitoring and/or a hygiene compartment and/or a humidity compartment and/or a humidity regulator and/or a vacuum pump and/or a vacuum compartment.

In order to be able to reduce the number of components of the household appliance and to produce the primary control device in larger numbers, the primary control device can include a user interface and/or the primary control device can be integrated into the user interface of the household appliance apparatus and in particular of the household appliance.

Additionally or alternatively, the primary control device can include a central processing unit for controlling consumer units, preferably DC consumer units, in particular of an actuator and/or of a lighting unit, which for example includes illuminants, and sensors.

The user interface can be an interface to regulate a temperature and/or a degree of refrigeration and/or the DC consumer units.

As a result, the primary control device can in particular be employed in virtually all or in all household appliance configurations, since virtually all or all household appliance configurations have a user interface and/or a central processing unit. The central processing unit can for example serve as the seat of the main software of the household appliance apparatus. For example, the primary control device includes power and regulation electronics for DC consumer units and/or for DC components of the household appliance apparatus and in particular of the household appliance, which for example are regulated on the basis of input data from sensors of the household appliance apparatus and in particular of the household appliance. The primary control device can have power and regulation electronics for the user interface of the household appliance. Furthermore, the primary control device can include a digital control unit and/or can be configured as such.

In order to be able to integrate the control of as many components as possible, which can in particular be employed for all household appliance configurations, into a control device, the power control device can include a refrigerator power unit controller. Additionally or alternatively, the power control device can have a compressor controller and/or a fan controller. In addition, the power control device can have an interface, via which the household appliance apparatus can be connected to a voltage supply. Further, the power control device can be the seat of an AC/DC power pack, by which the further control devices and/or functions of the household appliance apparatus can be supplied with a DC voltage, in particular a safety extra low voltage. As a result, the power control device can be produced inexpensively in large numbers. The power control device can in particular include and/or be a power unit motor unit.

The primary control device and/or the at least one function control device can each preferably be configured as safety extra low voltage components and the power control device as a mains voltage component. In this case the primary control device and/or the at least one function control device can be supplied with a safety extra low voltage, in particular with a 12V voltage, via the bus connection. The power control device can be connected to the voltage supply with the AC voltage, and can include a filter unit in order to filter the AC voltage.

By configuring the primary control device as a safety extra low voltage component the normative requirements on the primary control device and the at least one function control device can be reduced. Furthermore, the primary control device and the at least one function control device must meet lower requirements as regards contact protection. Further, they can be manufactured more simply; for example there is no need to adhere to a minimum pull-off force (disassembly force) when assembling the primary control device and/or the at least one function control device. Further, it is possible to reduce the requirements for fire protection placed on the primary control device and/or the at least one function control device, and manufacturing from less expensive raw materials can be enabled. Additionally, by configuring the primary control device and/or the at least one function control device as a safety extra low voltage component these can be installed with a smaller spacing from insulations and/or with a smaller air gap between the primary control device and/or the at least one function control device and the insulation. As a result, the size of the PCB (printed circuit board) and the size of the housing can be reduced. Furthermore, the overall size of the household appliance can as a result be reduced and/or the usable space available can be increased.

Furthermore, as a result the configuration of the primary control device and/or of the at least one function control device as a safety extra low voltage component can prevent cables via which the (high) AC voltage is transmitted from having to be routed through the entire household appliance. As a result, electromagnetic compatibility can be improved.

Further, because AC components that require a larger installation space are no longer necessary in the primary control device and/or the at least one function control device, fewer cables with a lower cable cross-section are employed. Furthermore, less expensive plugs can be used, for example RAST2.5 instead of RAST2.5p plugs.

The power control device can preferably provide a safety extra low voltage for the primary control device and the at least one function control device via the bus connection.

For example, the power control device includes a power pack, by which a connection to country-specific supply lines can be produced. Furthermore, the power control device can have an interface for programming country-specific requirements. Thus the household appliance apparatus can be adapted to the country-specific requirements with little effort.

In particular, the bus connection is configured as a D-bus and/or a CAN-bus. The bus connection is preferably exclusively configured as a D-bus, to ensure simple and inexpensive power and data transmission as well as programming of the data transmission. In order to enable fast communication between the individual control devices, the bus connection can alternatively also be configured as a CAN-bus. However, it is also conceivable for the bus connection to include a D-bus and a CAN-bus, in order to be able to adapt the data transmission more precisely to its specific requirements.

In particular, the power control device, the primary control device and/or the at least one function control device for power and data transmission can exclusively be connected via the bus connection. As a result, the number of cables in the household appliance can be greatly reduced.

In order to further reduce the number of electronic components, the power control device can be connected, in particular via the bus connection, directly to the at least one function control device, and/or the primary control device can be connected, in particular via the bus connection, directly to the at least one function control device, in particular in each case without a further device, in particular a control device, therebetween.

In one configuration of the invention the at least one function control device can be disposed between the power control device and the primary control device as regards the height direction. As a result, the power control device and the primary control device, which can include sensitive components, such as for example the user interface, are advantageously far away from one another. Furthermore, the function control device can be disposed directly on a function unit which is controlled by the function control device. As a result, the length of a cable between the function control device and the function unit which is controlled by the function control device can be reduced.

In particular, the household appliance apparatus can have a usable space, in particular a refrigeration space, a further usable space, in particular a freezing space, and a further function control device. The function control device can for example include a refrigeration system controller and/or an ice maker controller for the usable space. The further function control device can include a further refrigeration system controller and/or a further ice maker controller for the further usable space. Thus the same electronics architecture can be used for household appliances with only one usable space and for household appliances with at least two usable spaces. In contrast to the configuration with one usable space, the configuration with two usable spaces only requires the addition of a further function control device.

In order to reduce the length of a cable between the function control device and the function unit which is controlled by the function control device, the function control device can be disposed behind the usable space and the further function control device behind the further usable space.

Furthermore, the household appliance apparatus can include a housing which defines a usable space, in particular a refrigeration space, and the at least one function control device is disposed on the back of the housing on the housing and/or is disposed in the housing. The at least one function control device can in particular be plugged into the back of the housing. The at least one function control device can in particular be plugged and/or snapped into a frame. The frame can have a cover, as a result of which the at least one function control device can be covered, in particular sealed, to the outside. In particular, a 2K seal can be attached between the frame and the cover.

In particular, the primary control device can be at least partially surrounded by the insulating layer of the housing. In particular, the primary control device can be installed with smaller spacings from the insulating layer, in particular with a smaller air gap between the primary control device and the insulating layer. As a result, the overall size of the household appliance can be reduced and/or an available usable space can be increased.

In particular, the household appliance apparatus has a machine space, which is defined by the housing and in and/or on which the power control device is disposed. As a result, it is ensured that for example the AC components which are installed in the power control device are well shielded from the other DC components of the household appliance and/or of the household appliance apparatus. Further, good accessibility to the power control device can be ensured, for example for maintenance and/or repair purposes.

In order to protect the primary control device against environmental influences, the primary control device can in particular be introduced into the housing. Further, the primary control device can be at least partially surrounded by an insulating layer of the housing and in particular can be foamed into the insulating layer. As a result, the primary control device can be inexpensively integrated into the housing. In particular, the primary control device is integrated into the housing on the top of the housing. As a result, the primary control device is shielded against the power control device. In order to be able to shield the primary control device even better from the power control device, the power control device is preferably disposed in a lower area of the housing.

Furthermore, to this end the household appliance apparatus can have a machine space which is defined by the housing and in and/or on which the power control device is disposed.

The present invention is described below by way of example on the basis of the appended figures. The drawing, the description and the claims contain numerous features in combination. The person skilled in the art will expediently also consider the features individually and use them purposefully in combination in the context of the claims.

If there is more than one example of a particular object, where appropriate only one thereof is provided with a reference character in the figures and in the description. The description of this example can be transferred correspondingly to the other examples of the object. If objects are named in particular by using number words, such as first, second, third object, etc., these are used to name and/or assign objects. Therefore for example a first object and a third object may be included, but not a second object. However, a number and/or an order of objects could additionally also be derived on the basis of number words.

Other features which are considered as characteristic for the invention are set forth in the appended claims.

Although the invention is illustrated and described herein as embodied in a household appliance apparatus and a household appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a fragmentary, diagrammatic, side-elevational view of a household appliance with a household appliance apparatus according to the invention; and

FIG. 2 is a perspective view of a further embodiment example of a household appliance with a household appliance apparatus according to the invention.

### DETAILED DESCRIPTION OF THE INVENTION

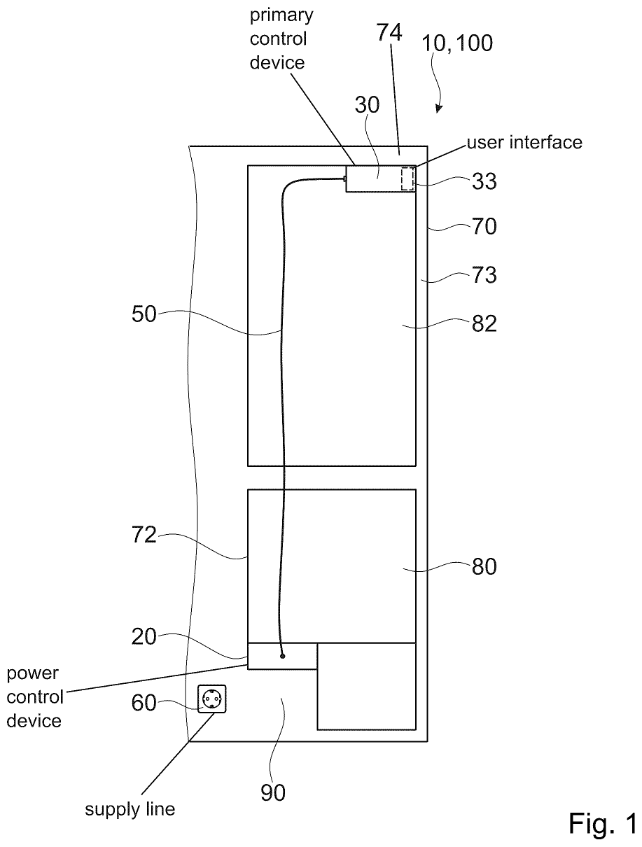

Referring now to the figures of the drawings in detail and first, particularly, to FIG. 1 thereof, there is seen an exemplary embodiment of a household appliance apparatus 10 according to the invention, which is part of an exemplary household appliance 100. The household appliance 100 is in this case configured as a floor-standing refrigerator. By way of example, the household appliance apparatus has a usable space 80 and a further usable space 82 which are defined by a housing 70 of the household appliance apparatus 10. The usable spaces 80, 82 can be closed by a common door or by separate doors of the household appliance apparatus 10. The usable space 80 can be a refrigeration space and the further usable space 82 can be a freezing space.

The housing 70 can include and/or form a machine space 90. The machine space 90 is disposed below the further usable space 82. A compressor (not shown) can for example be disposed in the machine space 90.

The household appliance apparatus 10 includes a power control device 20 and a primary control device 30, which are connected to one another via a bus connection 50. The housing 70 has an insulating layer 74 at least partially surrounding the primary control device 30.

The power control device 20 is disposed in the machine space 90. By way of example, the power control device 20 is introduced into the machine space 90 such that it is flush with a back 72 of the housing 70. The power control device 20 is fastened to a wall of the housing 70, for example screwed or snapped in. The power control device 20 is in operation connected to a country-specific supply line 60.

The primary control device 30 is by way of example disposed above the usable space 82, such that it is flush with a front 73 of the housing. The primary control device 30 is accommodated in a wall of the housing 70. For example, a user interface 33 of the household appliance apparatus 100 can be integrated into the primary control device 30, and is flush with the front 73 of the housing, and as a result is disposed in the household appliance such that the user interface 33 is easily accessible.

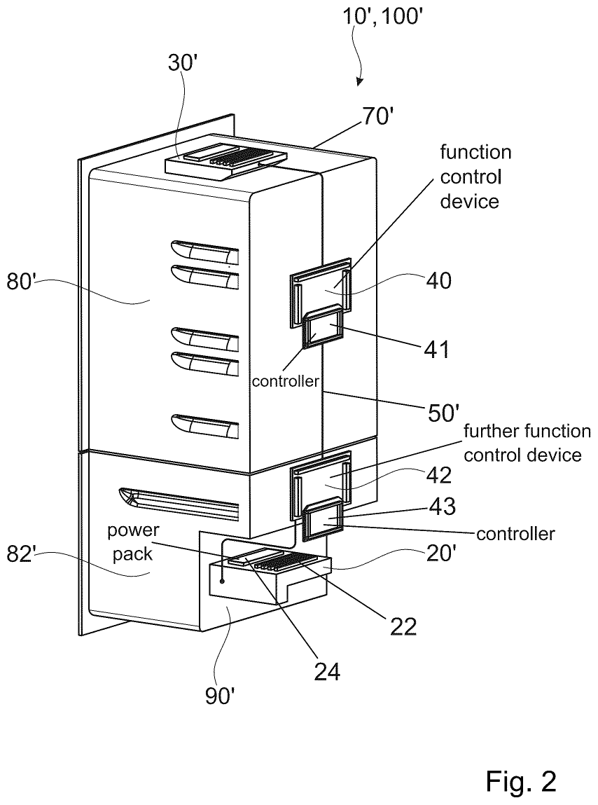

FIG. 2 shows a further exemplary embodiment of a household appliance apparatus 10′ according to the invention, which is part of an exemplary household appliance 100′. By way of example, the household appliance apparatus has a usable space 80′ and a further usable space 82′. The usable space 80′ and the further usable space 82′ can be disposed in a housing 70′.

The household appliance apparatus 10′ includes a power control device 20′ having an electrical interface 22 and a power pack 24, a primary control device 30′, a function control device 40 having a controller 41 for a refrigeration system or an ice maker, and a further function control device 42 having a controller 43 for a refrigeration system or an ice maker. The power control device 20′, the further function control device 42, the function control device 40 and the primary control device 30′ are connected to one another via a bus connection 50′.

For example, the power control device 20′ is initially connected to the further function control device 42. The further function control device is subsequently connected to the function control device 40 and then the function control device is connected to the primary control device 30′. The power control device 20′ is disposed in a machine space 90′ which is formed by the housing 70′ and is disposed below the further usable space 82′.

The primary control device 30′ is disposed above the usable space 80′. Furthermore, the function control device 40 and the further function control device 42 are disposed in a height direction between the power control device 20′ and the primary control device 30′. In this case the function control device 40 is disposed on the back of the usable space 80′ and the further function control device 42 is disposed on the back of the further usable space 82′.

The following is a summary list of reference numerals and the corresponding structure used in the above description of the invention:
10, 10′ Household appliance apparatus
20, 20′ Power control device
21 Bus port
22 Electrical interface
24 Power pack
30, 30′ Primary control device
31 Sensor connection
32 Illuminant connection
33 User interface
40 Function control device
41 Controller
42 Further function control device
43 Controller
50, 50′ Bus connection
60 Country-specific supply line
70, 70′ Housing
71 Top
72 Back
73 Front
74 Insulation
80, 80′ Usable space
82, 82′ Further usable space
90 Machine space
100, 100′ Household appliance
110 Door
120 Hygiene controller

1. A household appliance apparatus or household refrigerator apparatus, comprising:
a housing defining a usable space or a refrigeration space, said housing having upper and lower areas;
a power control device;
a primary control device being spatially separate from said power control device; and
a bus connection for combined power and data transmission between said power control device and said primary control device;
said power control device being disposed in said lower area of said housing and said primary control device being disposed in said upper area of said housing.

2. The household appliance apparatus according to claim 1, wherein said power control device and said primary control device are exclusively connected via said bus connection for power and data transmission.

3. The household appliance apparatus according to claim 2, wherein said bus connection is configured as at least one of a D-bus or a CAN-bus.

4. The household appliance apparatus according to claim 1, wherein said housing has a top, and said primary control device is disposed on said top of said housing.

5. The household appliance apparatus according to claim 1, wherein said housing has an insulating layer at least partially surrounding said primary control device.

6. The household appliance apparatus according to claim 1, which further comprises a machine space defined by said housing, said power control device being disposed at least one of in or at said machine space.

7. The household appliance apparatus according to claim 1, wherein said primary control device is configured as a safety extra low voltage component, and said power control device is configured as a mains voltage component.

8. The household appliance apparatus according to claim 1, wherein said power control device provides a safety extra low voltage for said primary control device via said bus connection.

9. The household appliance apparatus according to claim 1, wherein said power control device includes a power pack for producing a connection to country-specific supply lines.

10. The household appliance apparatus according to claim 1, wherein said power control device has an interface for programming country-specific requirements.

11. The household appliance apparatus according to claim 1, which further comprises at least one function control device disposed spatially between said power control device and said primary control device in a height direction of said housing.

12. The household appliance apparatus according to claim 11, which further comprises a further usable space or freezing space, and a further function control device, said function control device including at least one of a refrigeration system controller or an ice maker controller for said usable space, and said further function control device including at least one of a refrigeration system controller or an ice maker controller for said further usable space.

13. A household appliance, comprising the household appliance apparatus according to claim 1.
